(19) United States
(12) Patent Application Publication
(10) Pub. No.: US 2024/0338659 A1
(43) Pub. Date: Oct. 10, 2024

(54) MACHINE LEARNING SYSTEMS AND METHODS FOR AUTOMATED GENERATION OF TECHNICAL REQUIREMENTS DOCUMENTS

(71) Applicant: Open Weaver Inc., Miami, FL (US)

(72) Inventors: Ashok Balasubramanian, Chennai (IN); Karthikeyan Krishnaswamy Raja, Chennai (IN); Lakshmipathy Ganesh Eswaran, Chennai (IN); Suresh Babu Konduru, Chennai (IN)

(73) Assignee: Open Weaver Inc., Miami, FL (US)

(21) Appl. No.: 18/131,688

(22) Filed: Apr. 6, 2023

(51) Int. Cl. G06Q 10/10; G06F 8/10

(52) U.S. Cl. CPC G06Q 10/103; G06F 8/10

(57) ABSTRACT

A computer-implemented method for generating a technical requirements document from a business requirements document includes extracting section headers and section content from the business requirements document, extracting entities from the section content using an entities detection model, mapping the entities to technical terms using a master data dictionary, identifying key topics using topic modelling based on the section content, generating a summary of the section content by using the technical terms and section content as inputs to a machine learning model, and arranging the summary based on the key topics to generate the technical requirements document.

### BACKGROUND

The present disclosure relates generally to methods and systems for generating technical requirements documents, for example for software applications, computing systems, and the like. When a new or updated applications is desired, the features to be included in the application may be provided in the form of a business requirements document. The business requirements document describes features to be experienced by users and/or providers of the application (e.g., user-facing experience), as distinct from technical requirements for the application which, when implemented, enable the application to provide such user experiences. A technical challenge exists in generating technical requirements from a business requirements document, especially in an efficient manner without the need for expert human intervention. Solving such a challenge can streamline generation of new software applications and other technologies, providing an improvement in the field of software engineering and computer technologies.

### SUMMARY

One implementation of the present disclosure is a computer-implemented method for generating a technical requirements document from a business requirements document. The method includes extracting section headers and section content from the business requirements document, extracting entities from the section content using an entities detection model, mapping the entities to technical terms using a master data dictionary, identifying key topics using topic modeling based on the section content, generating a summary of the section content by using the technical terms and section content as inputs to a machine learning model, and arranging the summary based on the key topics to generate the technical requirements document.

Another implementation of the present disclosure is one or more non-transitory computer-readable media storing program instructions that, when executed by one or more processors, cause the one or more processors to perform operations. The operations include extracting section headers and section content from a business requirements document, extracting entities from the section content using an entities detection model, mapping the entities to technical terms using a master data dictionary, identifying key topics using topic modelling based on the section content, generating a summary of the section content by using the technical terms and section content as inputs to a machine learning model, and arranging the summary based on the key topics to generate the technical requirements document.

Another implementation of the present disclosure is a system including one or more processors and one or more non-transitory computer-readable media storing program instructions that, when executed by the one or more processors, cause the one or more processors to perform operations. The operations include extracting section headers and section content from a business requirements document, extracting entities from the section content using an entities detection model, mapping the entities to technical terms using a master data dictionary, identifying key topics using topic modelling based on the section content, generating a summary of the section content by using the technical terms and section content as inputs to a machine learning model, and arranging the summary based on the key topics to generate the technical requirements document.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a diagram of a system for automated conversion of business requirements documents to technical requirements documents, according to some embodiments.

FIG. 2 is a diagram of a portion of the system of FIG. 1, according to some embodiments.

FIG. 3 is a flowchart of a process for automatically converting a business requirements document to a technical requirements document which can be performed by the system of FIG. 1, according to some embodiments.

FIG. 4 is a flowchart of a process for classifying the document type of a business requirements document which can be performed by the system of FIG. 1, according to some embodiments.

FIG. 5 is a flowchart of a process for extracting contents from sections of a business requirements document which can be performed by the system of FIG. 1, according to some embodiments.

FIG. 6 is a flowchart of a process for finding entities in the contents of the business requirements document which can be performed by the system of FIG. 1, according to some embodiments.

FIG. 7 is a flowchart of a process for mapping the entities and content with the appropriate technology terms which can be performed by the system of FIG. 1, according to some embodiments.

FIG. 8 is a flowchart of a process for generating content for a technical requirements document using outputs of the processes shown in FIGS. 4-7, according to some embodiments.

FIG. 9 is a flowchart of a process for assembling the contents from the process of FIG. 8 into a technical requirements document, according to some embodiments.

### DETAILED DESCRIPTION

Referring generally to the figures, systems and methods for generating technical requirements documents for software applications, computing systems, and the like are shown, according to some embodiments. Without accurately-identified technical requirements to be satisfied by a software application, the software application will fail to provide the functionality desired by purveyors and/or users of such applications. However, desired functionality is often defined from a user-facing perspective or purveyor business perspective, for example based on user desires from voice-of-customer research, product strategy goals, and the like, rather than defined in terms of technical details that need to be implemented in software in order to achieve outcomes satisfying such goals and desires. As such, a technical challenge exists in translating such business requirements, which may be provided in a business requirements document, into technical requirements which enable development, engineering, coding, etc. of software to achieve such technical requirements. The teachings herein relate to automated systems and methods for generating technical requirements documents based on business requirements documents to enable accurate software development, thereby providing technical improvements in the computer arts.

Further, as should be appreciated from the following disclosure, embodiments of the present disclosure are implemented using a combination of artificial intelligence techniques (e.g., artificial intelligence models, machine learning models, neural network models, etc.) including natural language processing components, classification models, and components for generating and training various artificial intelligence models to identify key topics in business requirements documents, extract and classify content of business requirements documents, and generate technical requirements documents based on such outputs. The computational complexity of the approaches described herein is such that a human could not mentally, manually, etc. perform such operations, even with physical aids, and such that the processes herein are inherently technical and enable efficient and intelligent generation of technical requirements in a manner that can outperform (e.g., in terms of speed, efficiency, accuracy, etc.) other approaches including human analysis of documents and other approaches to automated document processing. These and other technical advantages of the teachings herein will become apparent from the following detailed description of the Figures.

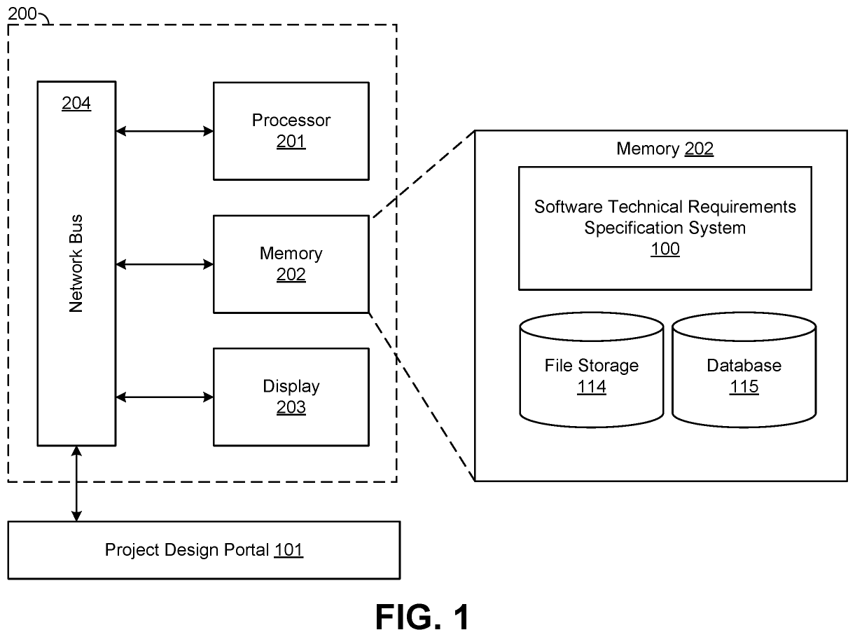

Referring now to FIG. 1, a block diagram of a system 200 is shown, according to some embodiments. The system 200 can be a computing system, for example including a computer (e.g., personal computer, laptop, desktop, tablet, smartphone, etc.), a server, a cloud computing system, a combination of computers, etc. in various embodiments. The system 200 is shown as including a processor 201 (e.g., one or more processors), memory 202 (e.g., one or more memory devices, computer-readable media, non-transitory memory, etc.), a display 203, and a network bus 204. The memory 202 stores program instructions that, when executed by the processor 201, cause the processor 201 to perform the operations described herein, according to various embodiments. The operations can include causing the display 203 to display a graphical user interface to a user relating to the operations described herein. As shown in FIG. 1, the processor 201, the memory 202, and the display 203 interoperate by communicating via network bus 204.

The network bus 204 is also shown as establishing and providing for communications between the system 200 and a project design portal 101. The project design portal 101 can be an application (e.g., mobile application, installed program, browser-accessible portal, etc.) through which a user can interact with the system 200. In some embodiments, the display 203 is omitted and the project design portal 101 is used for interfacing with users.

The memory 202 is shown as including a software technical requirements specification system 100, file storage 114, and a database 115. The memory 202 interoperates with the processor 201 such that the processor 201 executes operations attributed herein software technical requirements specification system 100 and elements thereof. As described in detail below, the system 200 is thereby configured to convert business requirements (e.g., in the form of a business requirements document) into technical requirements (e.g., to generate a technical requirements document).

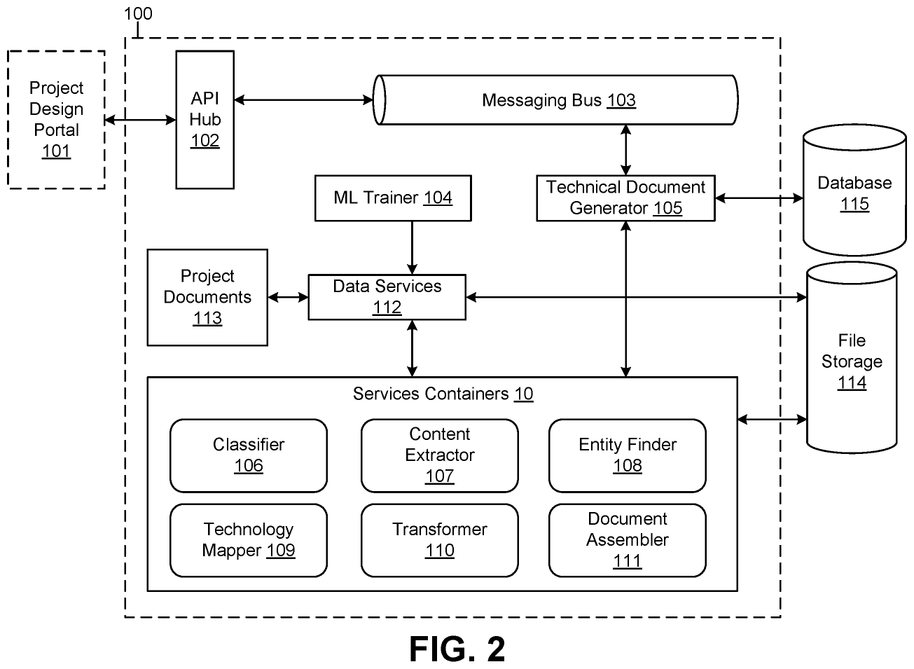

Referring now to FIG. 2, a block diagram of the software technical requirements specification system 100 is shown, according to some embodiments. As shown in FIG. 2, the software technical requirements specification system 100 includes an application programming interface (API) hub 102 communicable with the project design portal 101, a messaging bus communicable with the API hub 102, and a technical document generator 105 communicable with the messaging bus 103. The software technical requirements specification system 100 is also shown as including a machine learning (ML) trainer 104 communicable with the technical documents generator 105, data services 112 communicable with the ML trainer 104, with project documents 113, and services containers 10 of the software technical requirements specification system 100. The data services 112 are also shown as being communicable with file storage 114 while the technical document generator 105 is shown as being communicable with the database 115. The services containers 10 are shown as including a classifier 106, a content extractor 107, an entity finder 108, a technology mapper 109, a transformer 110, and a document assembler 111.

The project design portal 101 is a portal (interface, webpage, application, etc.) through which a user can submit a request for generation of a technical requirements based on business requirements. For example, the project design portal 101 can prompt a user for a business requirements document, receive the business requirements document, and provide the business requirements document to the API hub 102 (e.g., upload the business requirements document to the software technical requirements specification system 100). The project design portal 101 can allow the user to submit a business requirements document and also to view a technical requirements document generated by the system 100 based on the business requirements document. For example, the project design portal 101 can include a web form for the user to submit the business requirements document and a submit button to raise the request to perform the document conversion, among other possible inputs (e.g., contact information such as an email address for future notification, etc.). The project design portal 101 can provide status updates on submitted requests.

The API hub 102 is configured to receive a user request for generation of technical requirements and a business requirements document associated with the user request from the project design portal 101. For example, the API hub 102 may act as a gateway for accepting requests from the project design portal 101, for example by hosting web services for taking such requests. The API hub 102 may generate request messages and associated files (e.g., containing business requirements documents) and provide such messages and files onto the messaging bus 103. In some embodiments, multiple files are submitted with one request (e.g., as a combined business requirements document), for example files in PDF, spreadsheet, word document, text file, etc. formats.

The messaging bus 103 is configured to receive messages from the API hub 102, for example including requests to generate technical requirements and associated business requirements documents, and can provide for communication back to the project design portal 101 and users thereof (e.g., via API hub 102) when technical requirements have been generated (e.g., presentation in the project design portal 101, email notification to users). The messaging bus 103 thereby receives inputs to the processes executed by the system 100 and provides for communication of outputs of such processes out of the system 100. The messaging bus 103 may be configured with an event driven architecture that enables long running processes to be decoupled from requesting system calls, which can help the system 100 to service user requests and notify users once generation of technical requirements is complete. In some embodiments, job listeners are included to listen to messages in the messaging bus 103, with different types of messages triggering different jobs.

The ML trainer 104 is configured to provide training for the various machine learning models (e.g., natural language processing models, generative artificial intelligence models, etc.) described herein. The various machine learning models can be trained on data from the database 115 and/or file storage 114, and can be stored in the database 115 and/or file storage 114. The ML trainer 104 can interoperate with the data services 112 to obtain and manage data used by the ML trainer 104 in training models.

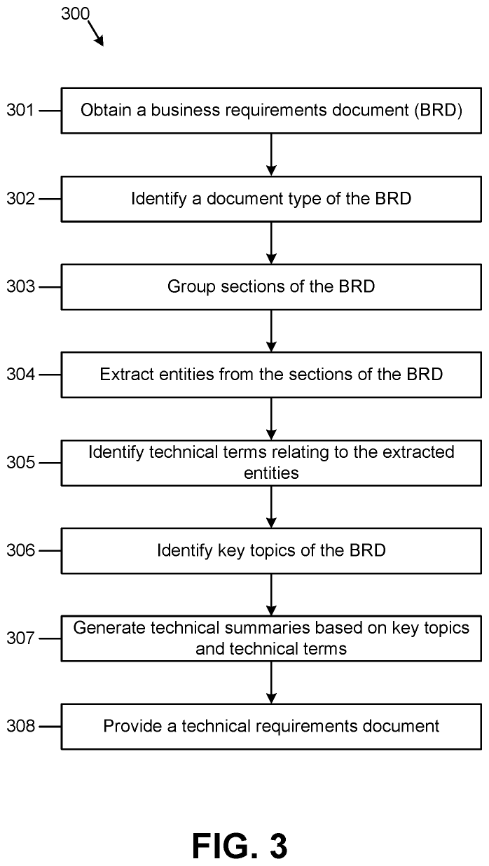

The technical document generator 105 is configured to coordinate execution of various services, steps, processes, etc. described herein to provide, as a combination of such services, steps, processes, etc., generation of technical requirements, for example generation of technical requirements documents. The technical document generator 105 is configured to read requests from the messaging bus 103 and initiate generation of technical requirements in response to such requests. As described in detail below, the technical document generator 105 utilizes and coordinates natural language processing and machine learning models (e.g., generated/trained by the ML trainer 104) for tasks described below including extracting contents, key topics, etc. from business requirements documents and generating technical summaries for output in technical requirements documents. For example, the technical document generator 105 can provide trained models from the ML trainer 114 to the services container 10, coordinate interoperation of components of the services containers 10, and coordinate provisions of data from database 115, files from file storage 114, and documents from project documents 113 to the various service containers 10, for example using data services 112, thereby coordinating the various processes herein into the overall process shown in FIG. 3 and described with reference thereto below.

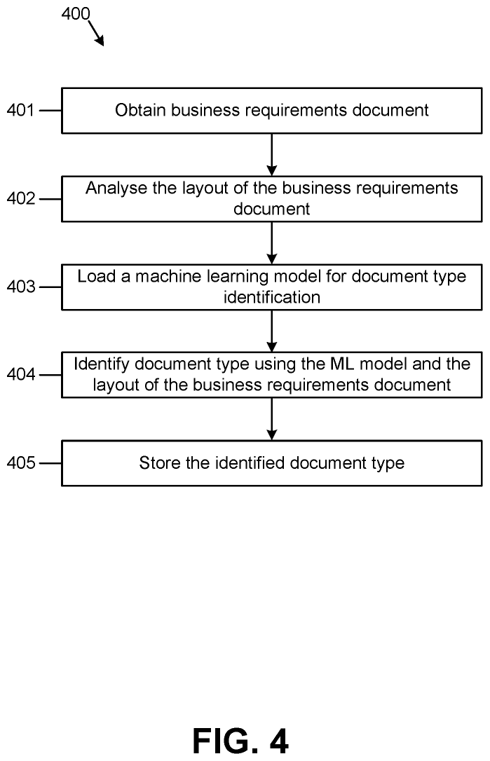

The classifier 106 is configured to identify a document type of a business requirements document and classify the business requirements document accordingly. The classifier 106 can execute process 400 of FIG. 4, in some embodiments, which is described in detail below. In some embodiments, the classifier 106 receives a business requirements document (e.g., as submitted by a user via the project design portal 101), analyzes the layout of the business requirements document, and identifies a document type of the business requirements document based on the layout and using an ML model (e.g., classifier, neural network classifier, Bayesian classifier). For example, the document type may indicate an industry associated with the business requirements document (e.g., manufacturing, banking, content sharing, etc.) or other high-level classification. The classifier 106 thereby outputs a classification (e.g., document type, industry, etc.) of the business requirements document.

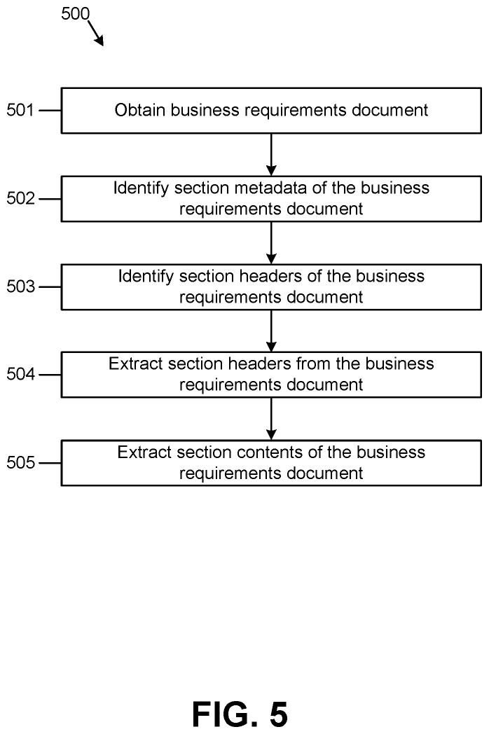

The content extractor 107 is configured to identify section contents and section headers of the business requirements document and to extract the section level content and headers. The content extractor 107 can use natural language processing to perform such operations, for example according to process 500 of FIG. 5, described in detail below. In some embodiments, the content extractor 107 uses section metadata and natural language processing techniques to identify section headers and section contents. The content extractor 107 can store section headers and contents extracted from the business requirements document in the database 115, in some embodiments.

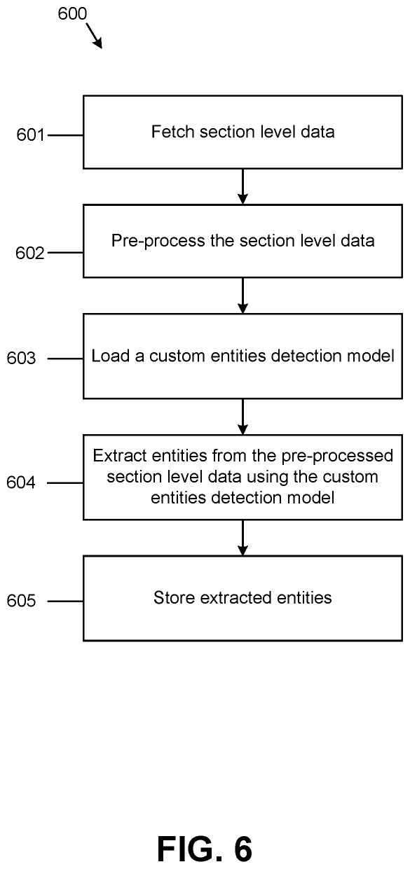

The entity finder 108 is configured to detect entities present in section contents and/or headers by applying natural language processing techniques to outputs of the content extractor 107. Entities found by the entity finder 108 may include technical categories, functionalities, etc. which contribute to technical requirements. In some embodiments, the entity finder 108 executes process 600 of FIG. 6, described in detail below. The entity finder 108 determines entities present in a business requirements document and can store the entities in the database 115.

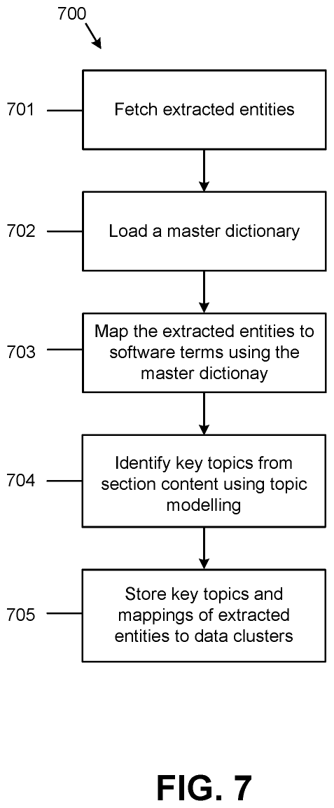

The technology mapper 109 is configured to map entities identified by the entity finder 108 to technical terms in a dictionary, database, table, etc. of technical terms relating to software development (e.g., terms suitable for use in technical requirements). In some embodiments, the technology mapper 109 executes process 700 of FIG. 7, which is described in detail below. In some embodiments, the technology mapper 109 also identifies technical topics associated with section headers and/or contents extracted from the business requirements document, for example using one or more machine learning techniques such as topic modelling. The mapped technical terms and/or topics identified by the technology mapper 109 are then stored in the database 115, in some embodiments.

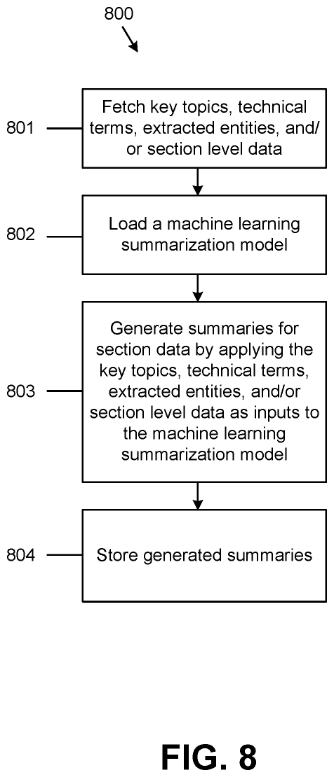

The transformer 110 is configured to use some or all of the section headers, section contents, extracted entities, technical terms, and technical topics identified by the content extractor 107, entity finder 108, and technology mapper 109 as inputs to a generative artificial intelligence algorithm (e.g., including one of more machine learning and/or deep learning algorithms) configured to output an abstractive summary of technical requirements for inclusion in a technical requirements document. In some embodiments, the transformer 110 is configured to execute process 800 of FIG. 8, which is described in detail below.

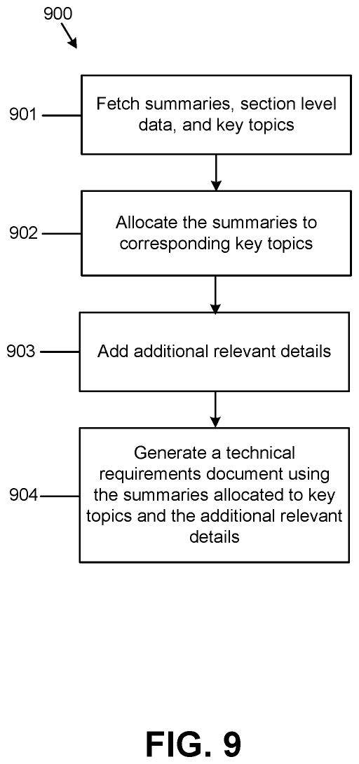

The document assembler 111 is configured to assemble (e.g., aggregate, compile, arrange, collate, etc.) topics (e.g., headings, categories, high level content descriptors, etc.) to be included in a technical requirements document along with corresponding summary text as produced by the transformer 110 to generate a technical requirements document. The document assembler 111 thereby assembles content from the transformer 110 and the technology mapper 109 to create a technical requirements document. In some embodiments, the document assembler 111 executes process 900 of FIG. 9, which is described in detail below. The technical requirement document is thereby produced as an output of the document assembler 111.

The services containers 10 are thus configured to generate, for example as coordinated by the technical document generator 105, a technical requirements document for provision to a user via the project design portal 101 based on a business requirements document provided by the user or otherwise received as an input to the system 100. The system 100 thereby converts the user-provided business requirements document into an automatically-generated technical requirements document. The technical requirements document can then be used by software engineers, automated software coding systems, etc. to generate a software application that satisfies the technical requirements identified in the technical requirements document. Generating the technical requirements document automatically and efficiently as by the system 100 thereby streamlines the overall software application development process and provides advantages in the computer arts.

Referring now to FIG. 3, a flowchart of a process 300 for generating a technical requirements document based on a business requirements document is shown, according to some embodiments. The process 300 can be executed by the system 200, for example by operation of the software technical requirements specification system 100. In some embodiments, the process 300 is coordinated by the technical document generator 105. The process 300 shown in FIG. 3 is the high level process performed by the system 200 to generate a technical requirements document. FIGS. 4-8 and the corresponding description provided below elaborate upon exemplary embodiments of particular actions and processing operations which can be included in the steps of process 300.

At step 301, a business requirements document is obtained. The business requirement document can be obtained at the messaging hub 103, for example via the API hub 102. In some embodiments, the business requirements document is obtained by providing, via the project design portal 101, an input field for a user to upload a business requirement documents (e.g., as a file in .pdf, .doc, .txt, etc. format) or enter free text of business requirements into the project design portal 101. The project design portal 101 can provide various forms, field, interface objects, etc. to facilitate collection of business requirements.

At step 302, a document type of the business requirements document is identified. Step 302 can include analyzing the layout of the business requirements document. Step 302 receives the business requirements document as an input and outputs a document type or other classification for the business requirements document. The document type or other classification can be used to select between machine learning algorithms, models, dictionaries, etc. used in other steps of process 300. Step 302 can include executing process 400 of FIG. 4, described below. In some embodiments, the classifier 106 executes step 302 using one or more machine learning models trained by ML trainer 104.

At step 303, sections of the business requirements document are grouped. Step 303 includes identifying section headers in the business requirements document and section contents, for example content associated with each of the identified headers. Step 303 can use machine learning and natural language processing techniques to identify (delineate, separate, group, etc.) and extract the section content and section headers. Step 303 can include executing process 500 of FIG. 5, described below. In some embodiments, the content extractor 107 executes step 303.

At step 304, entities are extracted from the sections of the business requirements document. Step 304 can use the extracted section content and/or section headers from step 303 and can identified entities present in, referred to in, involved in, etc. the section content and/or section headers. Entities can include technical categories, functions, programming languages, data storage requirements, etc. Step 304 can include executing process 600 of FIG. 6, described below. In some embodiments, step 304 is executed by the entity finder 108.

At step 305, technical terms relating to the extracted entities are identified. Identifying technical terms can be performed by comparing the extracted entities to a dictionary containing technical terms (e.g., terms appropriate for a technical requirements document). A clustering technique can be used to map entities to the most relevant and/or similar technical terms. At step 306, key topics of the business requirements document are identified, for example using one or more machine learning techniques such as topic modeling, and for example based on section contents extracted in step 304. Step 305 and step 306 can be implemented using process 700 of FIG. 7, described below. In some embodiments, step 305 and step 306 is executed by the technology mapper 109.

At step 307, technical summaries are generated based on the key topics and the technical terms identified in step 305 and step 306. The technical summaries can be generated using machine learning and/or deep learning summarization techniques (e.g., a generative artificial intelligence algorithm) to generate technical content suitable for a technical requirements document. Step 307 can include executing process 800 of FIG. 8, described below. Step 307 can be executed by the transformer 110.

At step 308, a technical requirements document is generated and provided. Step 308 can include assembling the summaries generated in step 307, augmenting the summaries with any suitable additional content, and providing the assembled technical requirements document to a user (e.g., via the project design portal 101). For example, summarized data for multiple sections can be allocated to technical section headers and compiled to form a technical requirements document. In some embodiments, the technical requirements document generated in step 308 is an electronic document or file, which can be provided in an electronic document format such as .pdf, .doc, .txt, etc. Step 308 can include executing process 900 of FIG. 9, described below. Step 308 can be executed by the document assembler 111, for example in collaboration with the technical document generator 105, the messaging bus 103, and the API hub 102.

Process 300 thereby results in a technical requirements document being generated and provided back to the user based on the business requirements document input by the user. The technical requirements document identifies technical features to be implemented in order for a resulting application, system, program, software, etc. to satisfy the business requirements listed in the business requirements document. In some embodiments, the technical requirements document is provided to another automated system, for example for a system configured for automatically finding, aggregating, and/or generating software code to satisfy the technical requirements of the technical requirements document.

Referring now to FIG. 4, a flowchart of a process 400 for identifying a document type of a business requirements document, according to some embodiments. Process 400 can be executed at step 302 of process 300, for example by the classifier 106.

At step 401, the business requirements document is obtained as an input to process 400. Obtaining the business requirements document can include fetching the business requirements document from the project design portal 101, database 115, file storage 114, project documents 113, or messaging bus 103. The business requirements document as obtained at step 401 may be in substantially the original form as provided by a user. The business requirements document may include text, images, logos, headers, footers, tables and can have various file formats (e.g., PDF, spreadsheet files, word processor files, etc.).

At step 402, the layout of the business requirements document is analyzed. Analyzing the layout of the business requirements document can include executing machine learning techniques such as clustering or machine vision, including optical character recognition. For example, metadata such as the position of text or images, breaks, grid lines, rows, columns, etc. can be generated by processing the business requirements document using machine learning techniques (e.g., machine vision techniques). Such metadata can differentiate areas of the business requirements document associated with different sections or types of content.

At step 403, a machine learning model for document type identification is loaded. For example, in step 403, a machine learning model can be loaded from the ML trainer 104 and/or database 115. The machine learning model for document type identification is trained to classify document types based on metadata, for example trained on metadata for a large number of documents identified in a similar manner as for step 402 and on a training dataset that already identifies document type for documents therein.

At step 404, the document type of the business requirements document is identified using the machine learning model for document type identification loaded in step 403 and based on the layout of the business requirements document determined in step 402 (e.g., based on layout-related metadata of the business requirements document). The machine learning model can use the metadata from step 402 as input and outputs, in step 404, a document type for the business requirements document. The document type is selected from types used in training the machine learning model, and can indicate different industries (e.g., manufacturing, consumer products, finance, banking, video games, etc.) for which different business requirements documents apply or other product categories (e.g., user-facing, backend, etc.) or can relate to different types of layouts (e.g., tables, lists, grids, etc.). For example, different layouts of formats for business requirements documents may be standard or more likely in different industries, such that layout metadata can be suggestive of the industry associated with a business requirements document.

In some embodiments, step 404 includes using image analysis to detect images such as logos in a document. A business requirements document may include a logo of a relevant component (e.g., in a header, footer, watermark, title page, etc.) and step 404 can include analyzing the logo using an image analysis algorithm to determine the relevant company, and, based on the company, a relevant domain, industry, etc. relating to the business requirements document. Image analysis can be performed in step 404 using machine learning techniques involving image recognition and analysis, for example using a convolutional neural network trained on logos of brands/businesses across domains and a dataset indicating a domain/industry/etc. for each logo. In other embodiments, a user can input an industry, company name (e.g., client or customer name), or other identifying information into the projection design portal 101 and such information can be used in process 400.

At step 405, the identified document type is stored, for example in the database 115, file storage 114, or project documents 113. The identified document type can be stored as metadata (as a tag, etc.) on the business requirements document. The business requirements document is thereby associated in computer memory with the identified document type, such that that the identified document type can be accessed in later steps, by other computing components, etc. and used to guide further processing. Step 405 can also include storing layout metadata determine in step 402 with the business requirements document.

Referring now to FIG. 5, a flowchart of a process 500 for identifying and extracting section headers and section content data from a business requirements document is shown, according to some embodiments. Process 500 can be executed at step 303 of process 300, for example by the entity finder 108.

At step 501, the business requirements document is obtained, for example including the document type and/or layout metadata generated and stored with the business requirements document in process 400. Step 501 can include providing the business requirements document and associated document type and/or layout metadata to the content extractor 107 form the database 115, file storage 114, or project documents 113.

At step 502, section metadata of the business requirements document is identified. Step 502 can include automatically scanning through the document and accurately identifying text data through metadata including text data presence, position of the text, and other rules by applying natural language processing or other machine learning techniques, for example clustering of text data in the business requirements document, which may be helpful in differentiating between section headers and section content. Step 502 can be executed using one or more models trained by the ML trainer 104, for example with the document type and/or metadata from process 400 as inputs to the one or more models and section metadata (e.g., data differentiating sections, section headers, section contents, etc.) as outputs of the one or more models. Step 502 can include determining text related information such as font size, font style, text position, spacing or tabs in a document, etc.

At step 503, section headers of the business requirements document are identified. Step 503 can include using text related information such as font size, font style, text position, spacing or tabs in a document, etc. and/or other document type and layout metadata information as inputs to one or more natural language processing and/or machine learning models (e.g., clustering models) trained (e.g., by ML trainer 104) to identify section headers based on such inputs. Step 503 can include clustering and grouping words in the business requirements document together based on spacing among the words based on clustering techniques like K-Means clustering or Fuzzy C-Means clustering, and each cluster of words can be used to help in identifying and distinguishing between section headers and section contents. For example, headers may be recognized based on bold font size, greater font size compared to a majority of other text in a business requirements document, enumeration or other outline structure (e.g., bullet points), alignment, etc. Step 503 can thus result in section headers being identified, e.g., differentiated from other content of a business requirements document.

At step 504, section headers are extracted from the business requirements document. Step 504 can include creating and storing a list separate from the business requirements document that includes the section headers as identified in step 503 (i.e., without other content of the business requirements document). The section headers can be stored in the database 115, file storage 114, and/or project documents 113, in various embodiments.

At step 505, section contents are extracted from the business requirements document. Step 505 can include separating section contents (e.g., contents under the various identified section headings, for example identified as text remaining after identification of headers, text under headers, etc., for example as may be detected based on regular font (not bold or underlined, etc.), smaller font size than headers, separated from the section header (e.g., by a line break or the like). Step 505 can include storing the section contents in the database 115, file storage 114, and/or project documents 113, in various embodiments.

As a result of steps 504 and 505, in some embodiments the section content and section header data is stored in a structured data format suitable for use in later processing steps. This approach enables process 600 of FIG. 6 and other processes described herein to run reliably on a pre-processed business requirements document (e.g., on extracted section headers and section contents), rather than on (or in addition to) raw, unstructured business requirements document files that may differ significantly between one another. Such processing thereby enables higher reliability, performance, and efficiency in process 300 and in processes 600, 700, 800, and 900 described below, and in operation of system 100. The extracted section headers and section content is referred to as section level data in the following description.

Referring now to FIG. 6, a flowchart of a process 600 for extracting entities of the business requirements document is shown, according to some embodiments. Process 600 can be executed at step 304 of process 300, for example by the entity finder 108.

At step 601, section level data is fetched (obtained, received, accessed, etc.). Step 601 can include receiving the outputs of process 500 as inputs, e.g., obtaining section headers and section content extracted from a business requirements document. Section data for example
Section header: Account Opening.
Section content: Customer usually gives Aadhar/Pan card for proof and the system should be able to get the customer details using the same. Biometric KYC option should be available. For Customer authentication, aadhar based e-signature facility should be available. Customer can give his her photo or if needed system should be able to capture customer live image. System should be flexible to integrate with the bank's existing Systems, or other Govt. systems for easy processing of account opening. Account opening time should not take more than 15 mins for the entire process. RBI Guidelines should be strictly followed for KYC verification. The Account Opening should be done through an online user portal to get customer data.

While one example of a section header and section content is provided above, it should be understood that this example is merely one of many different types of section headers and section content that may be contained in a business requirements document. It is contemplated that other business requirements documents may contain different headers and section content, all of which are within the scope of the present disclosure. The systems and methods described herein are capable of handling a variety of different types of business requirements documents and creating corresponding technical requirements documents, which are dependent on the contents of submitted business requirements documents. Such section level data is obtained in step 601 and used in subsequent steps of the process 600.

At step 602, section level data is pre-processed. Pre-processing the section level data can include cleansing the data from any grammar errors, hyperlinks (URLs), typographical errors, inconsistent sentence structure or phrasing, etc., for example by executing natural language processing techniques.

At step 603, a custom entities model is loaded. For example, the custom entities detection model may be loaded by the entity finder 108 from the database 114, for example as trained by the ML trainer 104. In some embodiments, step 603 includes selecting the custom entities detection model from a set of custom entities detection models associated with different industries, domains, etc. based on a determined document type of the business requirements document.

The custom entities detection model may be a natural language processing model which is created by feeding text data with annotated entities (e.g., human-assigned entities) to the ML trainer 104. The entities may include custom entities such as domain entities, different entities related to verticals, specific entities related to software terminology and components, etc. By manually applying entities to sample section level data and providing such annotated section level data (section level data plus manually-assigned entities) as inputs to the ML trainer 104, one or more machine learning models configured to automatically assign entities to section level data (i.e., custom entities detection model(s)) can be created and saved to be loaded in step 603.

In some embodiments, the custom entities detection model is trained from a pre-trained model that is configured to detect standard entities (e.g., such as detecting person/organization involved in a sentence, common actions, etc.) and adapting the pre-trained model to detect custom entities which may be specific to various domains of interest (e.g., banking, insurance, healthcare, manufacturing, etc.). For example, in some embodiments, the model is trained by annotating custom entities on training data and using the Custom Named Entity Recognition module of the Spacy library. Accordingly, the custom entities detection model can predict text relating to a particular entity and if present, map it to the corresponding entity.

At step 604, entities are extracted from the pre-processed section level data using the custom entities detection model loaded in step 603. Section level data as obtained at step 601 are applied as inputs to the custom entities detection model, which then outputs entities based on the section level data (i.e., entities found to be represented in, referred to in, present in, etc. the section level data). For the example section level data provided above, an output from the custom entities detection model may be:
{Aadhar/Pan card—[Identity verification]; Biometric KYC—[Identity verification]; Capture live image—[Identity verification]; Account opening—[User accounts]; KYC verification—[Identity verification]; Online user portal—[User interaction]}.
which can be provided as an output of step 604. Different entities will be extracted (e.g., determined, output, identified, etc.) in step 604 for different business requirements documents based on the particular section headers and section content contained within the business requirements documents.

At step 605, the extracted entities are stored. For example, step 605 can include storing the outputs of step 604 (the outputs of the custom entities detection model) in the database 115, in the file storage 114, or in the project documents 113. The extracted entities are thereby made available for use in further processing.

Referring now to FIG. 7, a flowchart of a process 700 for mapping entities to technical terms and identifying key topics is shown, according to some embodiments. Process 700 can be executed at steps 305 and 306 of process 300, for example by the technology mapper 109.

At step 701, extracted entities are fetched (obtained, accessed, received, taken as inputs, etc.). Step 701 can include the technology mapper 109 obtaining the extracted entities (e.g., as generated in process 600) from the database 115, the file storage 114, or the project documents 113. With respect to the example given above with reference to FIG. 6, step 701 would include obtaining data including the extracted entities:
{Aadhar/Pan card—[Identity verification]; Biometric KYC—[Identity verification]; Capture live image—[Identity verification]; Account opening—[User accounts]; KYC verification—[Identity verification]; Online user portal—/[User interaction]}
which may be provided as an output of step 604. The extracted entities are thereby made available as inputs to other steps of process 700.

At step 702, a master dictionary is loaded. The master dictionary contains relevant technical terms, for example terms relating to software engineering, computer programming, etc., associated with entities. For example, the master dictionary may include data pairs including one custom entity and one corresponding software-related term. In some embodiments, the master dictionary is generated using or is applied using one or more natural language processing models trained to map custom business entities to corresponding software terminology (e.g., trained on human-provided mappings between custom business entities and software terminology).

At step 703, the extracted entities are mapped to software terms. Step 703 can involve use of the master dictionary applied using machine learning techniques. For example, step 703 can include creating embeddings for the extracted entities and the terms in the master data dictionary, and then assigning entities as corresponding to the most similar/relevant data dictionary term through distance measures (i.e., between an extracted entity in vector form and master data dictionary terms in vector form) such as Cosine similarity, Jaccarrd distance, Euclidean distance, etc. Such an approach can be characterized as mapping entities to data clusters, where the data clusters are associated with technical terms in the master dictionary. To continue the example from above, the result of step 703 will give a mapped entity and the corresponding software terminology, such as:
{Online user portal—[User Interface], KYC verification—[API call]}.

At step 704, key topics are identified from section content using topic modelling. The key topics may be functional, non-functional, domain-related information, or other types of requirements. Step 704 can include using the section content as extracted from a business requirements document in step 505 of process 500 as inputs to topic modelling algorithm that uses models trained by the ML trainer 105 such as Latent Dirichlet allocation models. Such models can be trained based on training data that maps domain topics to keywords, and can be used to analyze keywords and assign keywords to topics and domains.

As an example illustrating step 704, a non-functional requirement in a business requirements document may include text such as:
“Account opening time should not take more than 15 mins for the entire process”
which is an important requirement but not a discrete function that the application needs to execute. An example functional requirement in a business requirements document is:
“RBI Guidelines should be strictly followed for KYC verification”
which signifies a function to be implemented.

An example of a technical requirement derived from a business requirements document can be:
“The Account Opening should be done through an online user portal to get customer data,”
which specifies a significant technical requirement involving a user interface for the use case. Given such content in a business requirements document (e.g., in section contents extracted in process 500 and used as an input in an example execution of step 704), an example output of step 704 is topic and technical term data:
{Online user portal—[Banking, Technical], KKYC verification—[Banking, Functional]}.

At step 704, key topics and technical terms (mapped entities) are stored for use in future steps. For example, the outputs of steps 703 and 704 can be stored in the database 115, the file storage 114, and/or the project documents 113. Process 700 thereby provides key topics and technical terms based on section contents and entities extracted from a business requirements document.

Referring now to FIG. 8, a flowchart of a process 800 is shown, according to some embodiments. Process 800 can be executed in step 307 of process 300, for example by the transformer 110.

At step 801, key topics, technical terms, extracted entities, and/or section level data is fetched. Step 801 can include accessing outputs of any or all of process 500, process 600, and process 700, for example as stored in the database 115, file storage 114, or project documents 113.

At step 802, a machine learning summarization model is loaded, for example obtained from the database 115 by the transformer 110. The machine learning summarization model may be trained by the ML trainer 104 using deep learning techniques, and may be a generative machine learning model. In some embodiments, the model loaded in step 802 is based on pre-trained generative models such as BART, GPT, Transformer T5, BERT, etc. and/or other encoder/decoder or transformer models, which are then trained (e.g., in transfer learning) based on data sets specific to software engineering and domains associated with technical requirements documents as contemplated herein.

At step 803, summaries of the section level data is generated by applying the key topics, technical terms, extracted entities, and/or section level data as inputs to the model loaded in step 802. The generated summaries can include technical requirements, such as statements in technical terms indicating required functions and the like for a software application to comply with the business requirements document. In step 803, the model is used in a generative manner to generate text aligned to the extracted entities and key topics for each section of the business requirements document. Accordingly, for a business requirements document with multiple sections (as delineated in process 500, for example), separate summaries can be generated in step 803 for each section.

To continue the example from above, an example of text that can be generated in step 803 given the example section contents, extracted entities, key topics, etc. provides as a sample above can be:
The solution should have the capability to fetch details from scanned documents like Aadhar, pan, ITR etc. if required.
The solution should be able to integrate with NSDL and UIDAI APIs to fetch customer detail etc.
The solution should have the ability to verify biometric KYC of the customer opening the account.
The solution should have Aadhar based e-signature facility for customer authentication of account opening application
The solution should be able to capture live image of the customer if required
The solution should be able to integrate with bank's other backend systems, CBS apis to send and receive application while creating the account

Authentication and Encryption methodology as per regulatory guidelines should be followed while integrating with other Systems.
The solution should be complied with the relevant regulatory statutory guidelines.
Software specification Document mentioned with detailed Rest API, SOAP endpoints etc. to be used in the solution should be shared and take sign-off before implementation.
The solution should have an UI to get user input.

Other text will be generated depending on the section contents, extracted entities, technical terms, and key topics associated with other business requirements documents.

In step 804, the summary or summaries generated in step 803 are stored, for example saved in the database 115, file storage 114, or project documents 113. Process 800 thereby provides for generation and storage of summaries reciting technical requirements.

Referring now to FIG. 9, a flowchart of a process 900 is shown, according to some embodiments. Process 900 can be executed at step 308 of process 300, for example by the document assembler 111.

At step 901, summaries, section level data, and key topics associated with a business requirements document are fetched. Step 901 can include accessing outputs of process 800, process 700, process 600, process 500, or process 400, for example by accessing data stored in the database 115, file storage 114, or project documents 113. Summaries, section level data, and key topics—for example generated in the manner described above—are made available as inputs for other steps of process 900.

At step 902, the summaries are allocated to corresponding key topics. Each summary can be mapped to the most relevant topic of the key topics (i.e., key topics). For example, each business section in a business requirements document may have a corresponding technical topic which is most relevant (most similar according to distance score or other approach). The summaries can be allocated to the relevant technical topics (the key topics) based on the determined similarities. Step 902 thereby provides for reorganization of content from the original organization shown in a business requirements document (e.g., organized based on a user or business perspective) into an organization driven by key technical topics (as is appropriate for a technical requirements document).

At step 903, additional relevant information is added to the allocated summaries. Step 903 can include adding information such as project deliverables, other related technical and non-functional aspects of the requirements such as project management workflows and timelines (e.g., design sign-off steps, testing/verification processes, maintenance and service related topics), mobile compatibility guidelines, or aesthetic guidelines. To provide an example, additional relevant information added in step 903 can include:
“Application execution time should be in green.”
Step 903 can be executed using natural language processing approaches and based on determining any sections or contents of the business requirements document not captured, processed, etc. in generating the summaries.

At step 904, a technical requirements document is generated using the summaries allocated to key topics and the additional relevant details. Step 904 can include assembling the summaries in an organization provided by the allocation to key topics (e.g., under headers associated with the key topics) and adding the additional relevant details from step 903. Generating the technical requirements document in step 904 can includes exporting the arranged summaries and additional relevant details in a common file format, such as in a form editable and manipulable by a user (e.g., .doc, .xls, .csv).

A technical requirements document is thereby generated as a file which can be provided to a user (e.g., via the project design portal 101) and then used, shared, interacted with, etc. by the user for purposes of creating software that satisfies the technical requirements represented in the generated summaries and other content of the technical requirements document. A technical requirements document can thereby be generated automatically from a business requirements document.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A computer-implemented method for generating a technical requirements document from a business requirements document, comprising:
extracting section headers and section content from the business requirements document;
extracting entities from the section content using an entities detection model;
mapping the entities to technical terms using a master data dictionary;
identifying key topics using topic modeling based on the section content;
generating a summary of the section content by using the technical terms and section content as inputs to a machine learning model; and
arranging the summary based on the key topics to generate the technical requirements document.

2. The computer-implemented method of claim 1, further comprising providing a graphical user interface configured to prompt a user to input the business requirements document.

3. The computer-implemented method of claim 1, further comprising identifying a document type of the business requirements document using a classifier model, wherein the classifier model uses layout metadata of the business requirements document as an input.

4. The computer-implemented method of claim 1, wherein extracting the section headers and the section content from the business requirements document comprises automatically distinguishing between the section headers and the section content based on font and layout information of the business requirements document.

5. The computer-implemented method of claim 1, wherein the entities detection model is a custom entities detection model adapted from a pre-trained entities detection model, the method comprising adapting the pre-trained entities detection model by providing a machine learning training processes using a dataset including custom entities associated with sample section content.

6. The computer-implemented method of claim 1, wherein the master data dictionary comprises the technical terms, the technical terms relate to software engineering, and mapping the entities to the technical terms comprises applying a data clustering approach.

7. The computer-implemented method of claim 1, further comprising outputting the technical requirements document to a user as an editable computer file.

8. One or more non-transitory computer-readable media storing program instructions that, when executed by one or more processors, cause the one or more processors to perform operations comprising:
extracting section headers and section content from a business requirements document;
extracting entities from the section content using an entities detection model;
mapping the entities to technical terms using a master data dictionary;
identifying key topics using topic modeling based on the section content;
generating a summary of the section content by using the technical terms and section content as inputs to a machine learning model; and
arranging the summary based on the key topics to generate a technical requirements document.

9. The one or more non-transitory computer-readable media of claim 8, the operations further comprising providing a graphical user interface configured to prompt a user to input the business requirements document.

10. The one or more non-transitory computer-readable media of claim 8, the operations further comprising identifying a document type of the business requirements document using a classifier model, wherein the classifier model uses layout metadata of the business requirements document as an input.

11. The one or more non-transitory computer-readable media of claim 8, wherein extracting the section headers and the section content from the business requirements documents comprises automatically distinguishing between the section headers and the section content based on font and layout information of the business requirements document.

12. The one or more non-transitory computer-readable media of claim 8, wherein the entities detection model is a custom entities detection model adapted from a pre-trained entities detection model, the method comprising adapting the pre-trained entities detection model by providing a machine learning training processes using a dataset including custom entities associated with sample section content.

13. The one or more non-transitory computer-readable media of claim 8, wherein the master data dictionary comprises the technical terms, the technical terms relate to software engineering, and mapping the entities to the technical terms comprises applying a data clustering approach.

14. The one or more non-transitory computer-readable media of claim 8, the operations further comprising outputting the technical requirements document to a user as an editable computer file.

15. A system, comprising:
one or more processors; and
one or more non-transitory computer-readable media storing program instructions that, when executed by the one or more processors, cause the one or more processors to perform operations comprising:
extracting section headers and section content from a business requirements document;
extracting entities from the section content using an entities detection model;
mapping the entities to technical terms using a master data dictionary;
identifying key topics using topic modelling based on the section content;
generating a summary of the section content by using the technical terms and section content as inputs to a machine learning model; and
arranging the summary based on the key topics to generate a technical requirements document.

16. The system of claim 15, wherein the operations further comprise providing a graphical user interface configured to prompt a user to input the business requirements document.

17. The system of claim 15, wherein the operations further comprise identifying a document type of the business requirements document using a classifier model, wherein the classifier model uses layout metadata of the business requirements document as an input.

18. The system of claim 15, wherein extracting the section headers and the section content from the business requirements documents comprises automatically distinguishing between the section headers and the section content based on font and layout information of the business requirements document.

19. The system of claim 15, wherein the master data dictionary comprises the technical terms, the technical terms relate to software engineering, and mapping the entities to the technical terms comprises applying a data clustering approach.

20. The system of claim 15, wherein the operations further comprise outputting the technical requirements document to a user as an editable computer file.
